(19) United States
(12) Patent Application Publication
(10) Pub. No.: US 2002/0013112 A1
(43) Pub. Date: Jan. 31, 2002

(54) Multi-drum manufacturing system for nonwoven materials

(76) Inventors: George J. Bontaites JR., Marblehead, MA (US); George Lee, Peabody, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/884,587

(22) Filed: Jun. 19, 2001

Related U.S. Application Data
(63) Continuation-in-part of application No. 09/733,147, filed on Dec. 8, 2000.
(60) Provisional application No. 60/212,562, filed on Jun. 20, 2000.
(60) Provisional application No. 60/286,802, filed on Apr. 25, 2001.

(51) Int. Cl. D04H 3/00; D04H 3/10; B32B 31/06; B32B 31/08; B32B 31/30

(52) U.S. Cl. 442/381; 425/72.2; 425/104; 425/174; 425/363; 156/379.6; 156/390; 156/501; 156/555; 156/244.11; 156/244.17; 156/244.24; 156/244.27; 156/276; 156/324; 264/464; 264/555; 264/103; 264/173.11; 264/175; 264/211.12; 442/382; 264/171.13; 442/389; 442/392; 442/393; 442/394

(57) ABSTRACT

A method of manufacturing a multi-layered web uses contoured honeycomb drums for the manufacture of non-woven webs used to make the multi-layered web. The method can use spunbonded, melt blown, or electro-static spun techniques for depositing solidifying filaments on outer collection surfaces of a multi-drum system. The multi-drum system may be employed to improve multi-layered web uniformity and the overall quality of the multi-layered web by presenting a single optimal collection surface for each independent web layer being produced.

### RELATED APPLICATIONS

This application is related to and claims priority to U.S. patent application Serial No. 60/212,562 entitled “Multi-Drum Manufacturing System for Nonwoven Materials,” filed on Jun. 20, 2000, U.S. patent application Serial No. 60/286,802 entitled “Method and Apparatus for Bonding a Non-Woven Web,” filed on Apr. 25, 2001, and U.S. patent application Ser. No. 09/733,147 entitled “Method and Apparatus for Controlling Flow in a Drum” filed on Dec. 8, 2000, which in turn claims priority to U.S. patent application Serial No. 60/170,037 entitled “Method and Apparatus for Controlling Flow in a Drum, filed on Dec. 10, 1999, International Patent Application No. PCT/US99/27294 entitled “Method and Apparatus for Manufacturing Non-Woven Articles” filed on Nov. 17, 1999, which in turn claims priority to U.S. patent application Ser. No. 09/193,582, filed Nov. 17, 1998, now U.S. Pat. No. 6,146,580 and U.S. Provisional patent application Serial No. 60/149,270, filed Aug. 17, 1999, all the disclosures of which are incorporated herein by reference in their entirety.

### FIELD OF THE INVENTION

This invention relates to a method of using non-woven fiber sources to produce a multi-layered web, and more particularly, forming the multi-layered web from nonwoven webs, where each web is formed independently on a separate drum.

### BACKGROUND OF THE INVENTION

Non-woven materials are used in applications that require articles to be air permeable. Some applications of non-woven articles are surgical masks and filter membranes. Since many applications that use non-woven material entail disposable articles, the non-woven articles should be easily manufacturable and low cost. Some methods of manufacturing non-woven materials are spunbonded and melt blown processes, and electro-spinning of nano-fibers.

FIG. 1 illustrates the spunbonded process 10 for manufacturing non-woven materials. Thermoplastic fiber forming polymer 12 is placed in an extruder 14 and passed through a linear or circular spinneret 16. The extruded liquid polymer streams 18 are rapidly cooled and attenuated by air and/or mechanical drafting rollers 20 to form desired diameter solidifying filaments 22. The solidifying filaments 22 are then laid down on a first conveyor belt 24 to form a web 26. The web 26 is then bonded by rollers 28 to form a spunbonded web 30. The spunbonded web 30 is then transferred by a second conveyer belt 32 and then to a windup 34. The spunbonded process is an integrated one step process which begins with a polymer resin and ends with a finished fabric.

FIG. 2 illustrates the melt blown process 40 for manufacturing non-woven materials. Thermoplastic forming polymer 42 is placed in an extruder 44 and is then passed through a linear die 46 containing about twenty to forty small orifices 48 per inch of die width. Convergent streams of hot air 50 rapidly attenuate the extruded liquid polymer streams 52 to form solidifying filaments 54. The solidifying filaments 54 subsequently get blown by high velocity air 56 onto a take-up screen 58, thus forming a melt blown web 60. The web is then transferred to a windup 62. U.S. Pat. No. 4,380,570 entitled “Apparatus and Process for Melt-Blowing a Fiberforming Thermoplastic Polymer and Product Produced Thereby” describes the melt blown process and is incorporated herein by reference in its entirety.

While non-woven materials can be manufactured by either the spunbonded or melt blown process, there are difficulties associated with each process. For example, the newly manufactured non-woven material (e.g. melt blown web 60) tends to stick to the take-up screen 58. Further, the processes produce sheet material. Accordingly, to manufacture non-woven materials into three-dimensional shapes, e.g. surgical masks and pleated filters, some form of post-processing is required.

In addition, non-woven processes for the production of spunbond and meltblown materials may use travelling belt collectors or drums upon which to form the non-woven materials or “webs.” Normally, a single drum or belt is used for this purpose. There has been some progress in the design of “multi-beam” equipment, where a traveling belt is used as a collector, and multiple spinnerettes are positioned over the belt in order to produce multi-layered webs of spunbond and meltblown materials.

The spinnerettes can be shifted to a variety of positions in order to produce composite webs of different structure, such as a layered spunbond/meltblown/spunbond (SMS) web. These layered webs can then be bonded or otherwise treated in a “post laydown” period to consolidate the layers.

Certain advantages can be achieved by use of this system. For example, one continuous belt acts as a transport system as well as a laydown area or collector for the meltblown or spunbond fibers. There are a number of disadvantages, however. For example, each layer must be collected on top of the last deposited layer of the web. Therefore, each time a layer of the web is collected on the belt, it blocks or changes the “air flow profile” on the collector, so as to present a less desirable collecting surface for the next layer of the web. Each subsequent layer of the web therefore is generally less uniform and of poorer overall quality.

### SUMMARY OF THE INVENTION

The present invention employs at least two drums, where each drum is made of a generally tubular honeycomb member having an outer collection surface for forming a non-woven web thereon. A non-woven fiber source applies solidifying filaments to each drum. A web transport system is provided for forming a multi-layered web.

In another embodiment of the present invention, a through-air bonding apparatus may be placed in proximity to at least one of the drums to add structural integrity to the non-woven web being formed on the drum.

In yet another embodiment of the present invention, one of the drums may have a contoured outer collection surface to form a contoured non-woven web. Optionally, filler material can be added in the contours to be incorporated into the multi-layered web.

Another embodiment of the present invention relates to a method of producing a multi-layer web. In one embodiment, the method includes providing at least two drums, each drum having a generally tubular honeycomb member with an outer collection surface for forming a non-woven web thereon. A non-woven fiber source applies solidifying filaments to each drum. A web transport system is provided for forming the multi-layered web. The method includes supplying non-woven fibers from the non-woven fiber sources to the corresponding drums, forming independently non-woven webs on each of outer collection surface of the drums, and forming the multi-layer web on the web transport system.

### BRIEF DESCRIPTION OF THE DRAWINGS

The above and further advantages of this invention may be better understood by referring to the following description, taken in conjunction with the accompanying drawings, in which:

FIG. 1 is a schematic of a spunbonded process for manufacturing non-woven materials;

FIG. 2 is a schematic of a melt blown process for manufacturing non-woven materials;

FIG. 3A is a perspective view of an embodiment of the drum of the current invention, illustrating a contoured honeycomb tube with an outer microporous surface;

FIG. 3B is a partially exploded side view of the drum illustrating a mounting structure, vacuum apparatus, and V-belt drive groove;

FIG. 3C is a partially exploded perspective view of the drum structure;

FIG. 4 is a partial cross-sectional view of the drum taken along line 4-4 in FIG. 3A illustrating a pleated surface of the drum;

FIG. 5 is a partial radial view of the drum illustrating the honeycomb mesh;

FIG. 6 is a cross-sectional view of the drum taken along line 6-6 in FIG. 3A illustrating a contoured outer surface having a three dimensional surface;

FIG. 7 is a schematic of a process of the current invention for the manufacture of non-woven materials that substantially match the contoured outer surface of the drum;

FIG. 8 is a schematic of a process of the current invention for the post processing of non-woven materials after a three dimensional contour has been formed;

FIG. 9 is a schematic perspective view illustrating a first material and a second material bridging a three dimensional contour;

FIGS. 10A-10C are schematic perspective views illustrating three embodiments of three dimensional shapes that can be formed in a non-woven material by a process of the current invention;

FIG. 11 is a schematic perspective view of a drum apparatus for the manufacture of non-woven materials;

FIG. 12 is a schematic perspective view of an outer drum sector and an inner vacuum tube assembly or manifold of the current invention;

FIG. 13 is a schematic perspective view of an inner tube and a vacuum shell of the manifold of the current invention;

FIG. 14 is a schematic top view of a vacuum frame of the inner tube and vacuum shell depicted in FIG. 13;

FIG. 15 is a partial cross-sectional view of the vacuum tube assembly taken along line 15-15 in FIG. 14;

FIG. 16 is a cross-sectional view of the inner tube and vacuum shell taken along line 16-16 in FIG. 15;

FIG. 17 is an exploded view of Detail 17 in FIG. 15;

FIG. 18 is a schematic bottom view of an inner tube of the manifold;

FIG. 19 is a schematic side view of the inner tube of the manifold;

FIG. 20 is a partial cross-sectional view of the inner tube taken along line 20-20 in FIG. 19;

FIG. 21 is a schematic perspective view of vanes for controlling air flow direction in the manifold;

FIG. 22 is a schematic side view of the shell and inner tube showing the orientation of the vanes for controlling air flow direction in the manifold;

FIG. 23 is a schematic perspective view of one set of vanes installed in the manifold;

FIG. 24 is a schematic exploded view of the inner tube, the vacuum shell, the vanes, the frame, the brackets, and the honeycomb of the manifold;

FIG. 25 is a perspective view of a drum and a through-air bonding apparatus for the manufacture of non-woven materials;

FIG. 26 is a front view of a drum and bonding manifold of the current invention;

FIG. 27 is a side view of a drum and through-air bonding system of current invention; FIG. 28 is a side view of a portion of the drum surface and manifold of the current invention;

FIG. 29 is a side view of a portion of a contoured drum surface and manifold of the current invention;

FIG. 30 is a table showing typical ranges of process parameters for the current invention;

FIG. 31 is a schematic diagram illustrating an apparatus for forming a multi-layered web; and

FIG. 32 is a schematic diagram illustrating another apparatus for forming a multi-layered web.

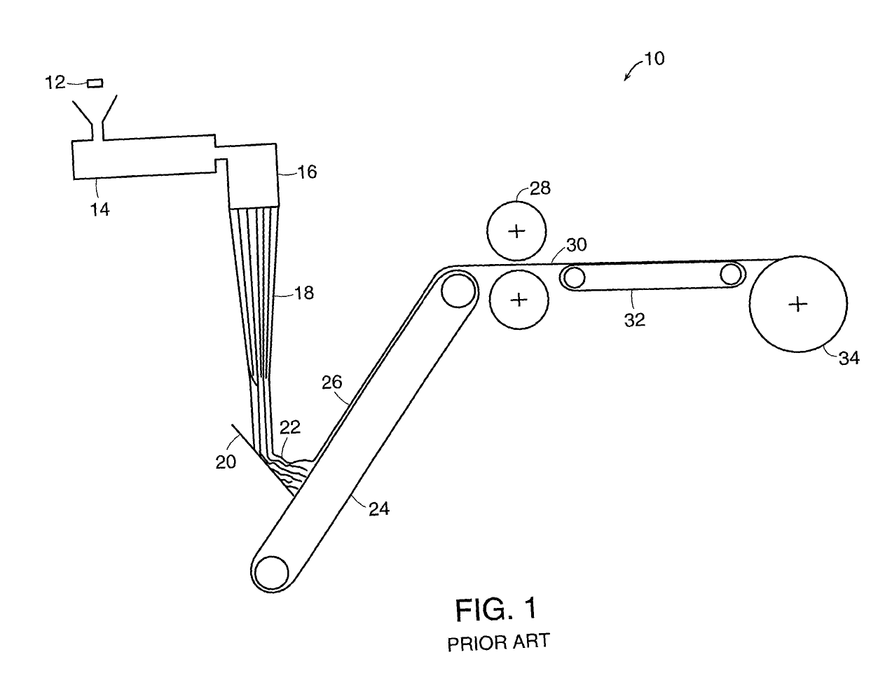

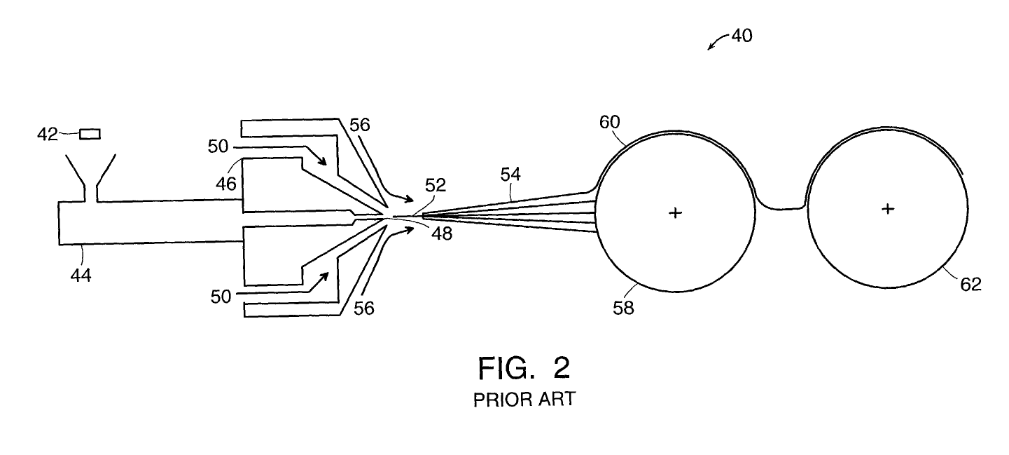

### DETAILED DESCRIPTION OF THE INVENTION

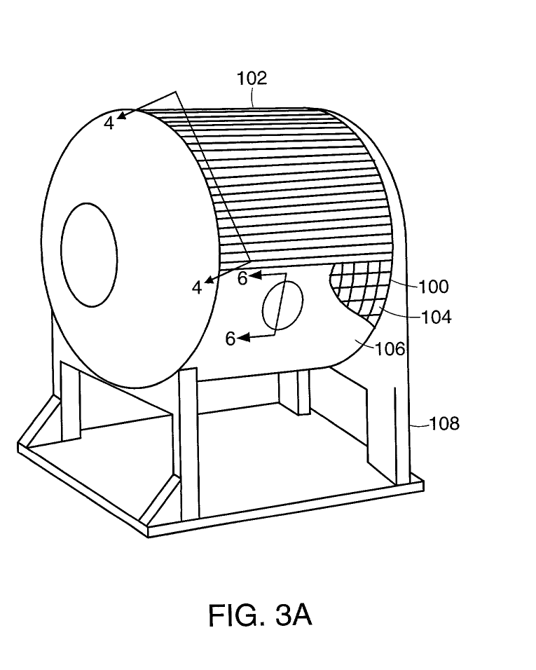

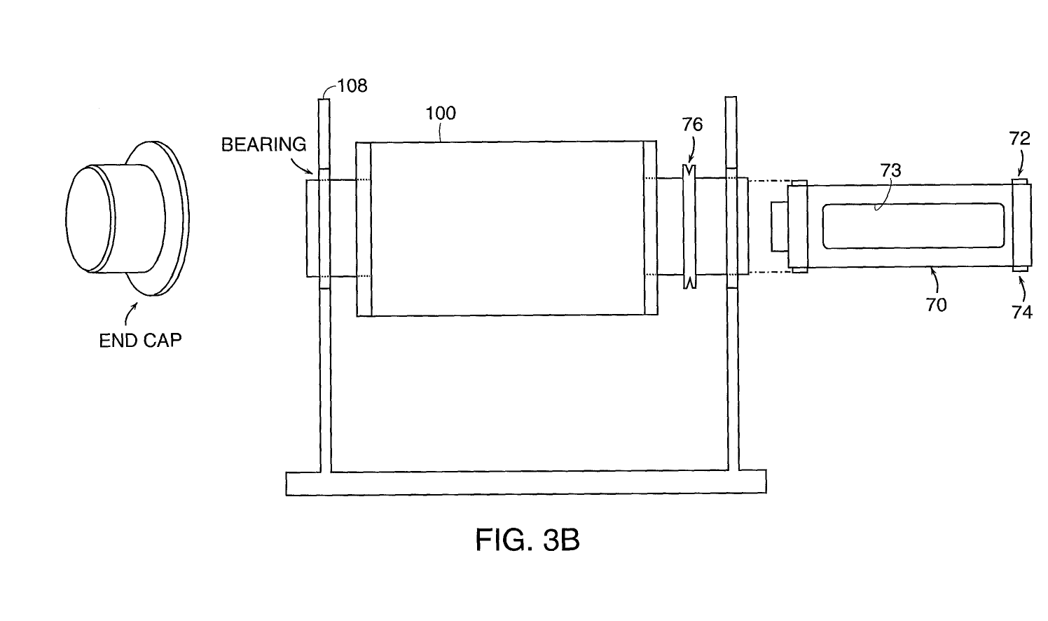

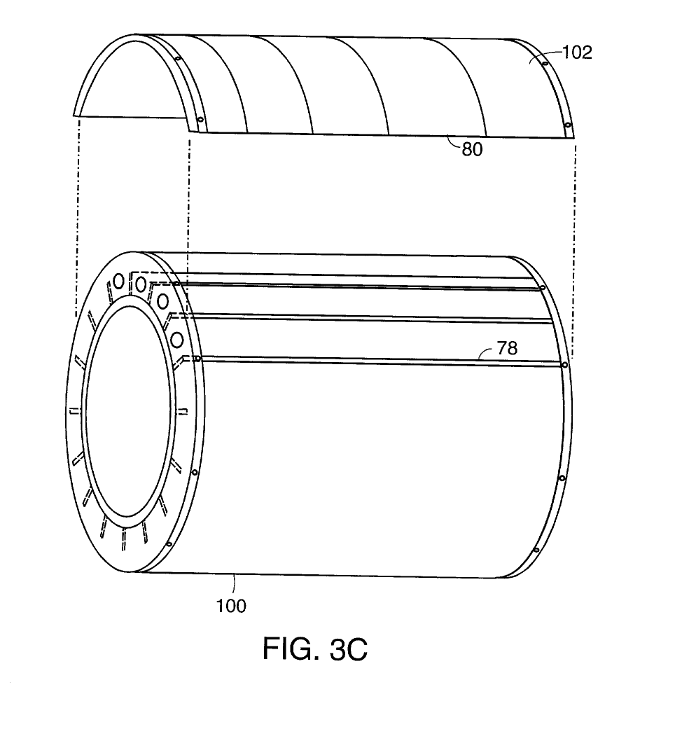

Referring to FIG. 3A, shown is a drum 100 having a contoured outer surface 102 which may take many different shapes and forms. As shown, the drum 100 is made of a tubular honeycomb member 104 that is surrounded by a microporous layer 106. The microporous layer 106 is tack welded to the tubular honeycomb member 104 and may be finely electroetched stainless steel having numerous holes on the order of about 0.010 inches (0.25 mm) in diameter, at a spacing such that the microporous layer 106 is uniformly about fifty percent open. A frame 108 rotatably supports the drum 100. The material for the tubular honeycomb member 104 can be, but is not limited to, stainless steel.

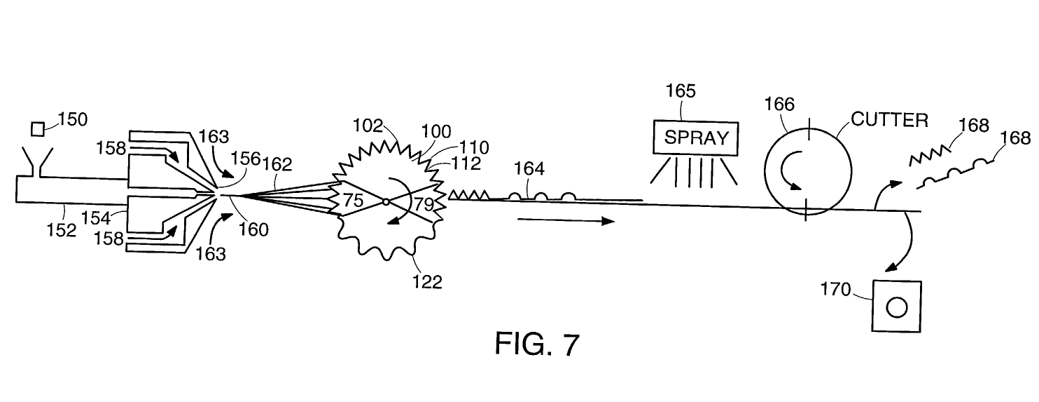

Referring to FIG. 3B, the drum 100 is supported by the frame 108 or frames, so that the drum 100 can be rotated as the solidifying filaments are continuously applied by spunbonded or melt blown processes or by electro-spinning of nano-fibers. FIG. 3B also shows an internal pipe 70 with a vacuum port 72 and a bearing surface 74. The pipe 70 is located in the center of the drum 100. The pipe 70 also has a slot 73 that is in communication with the vacuum port 72 to draw a negative pressure 75 through a sector of the drum 100 to conform the solidifying filaments to the contour. See FIG. 7. Also shown is V-belt drive 76 which can be used to rotate the drum 100 by any conventional source known to those skilled in the art, such as a variable speed motor.

Referring to FIG. 3C, the drum 100 includes inner support bars 78 which are located throughout the drum 100. The inner support bars 78 provide stiffness to the drum 100 and allow a negative pressure 75 or positive pressure 79 to be provided to a portion of the drum 100, as shown in FIG. 7. FIG. 3C also shows that the drum 100 includes a plurality of panels 80 that can attached to the drum 100 by a variety of means (e.g., fasteners or clips). The panels 80 can be made of honeycomb with a microporous outer layer to form any desired contoured outer surface 102.

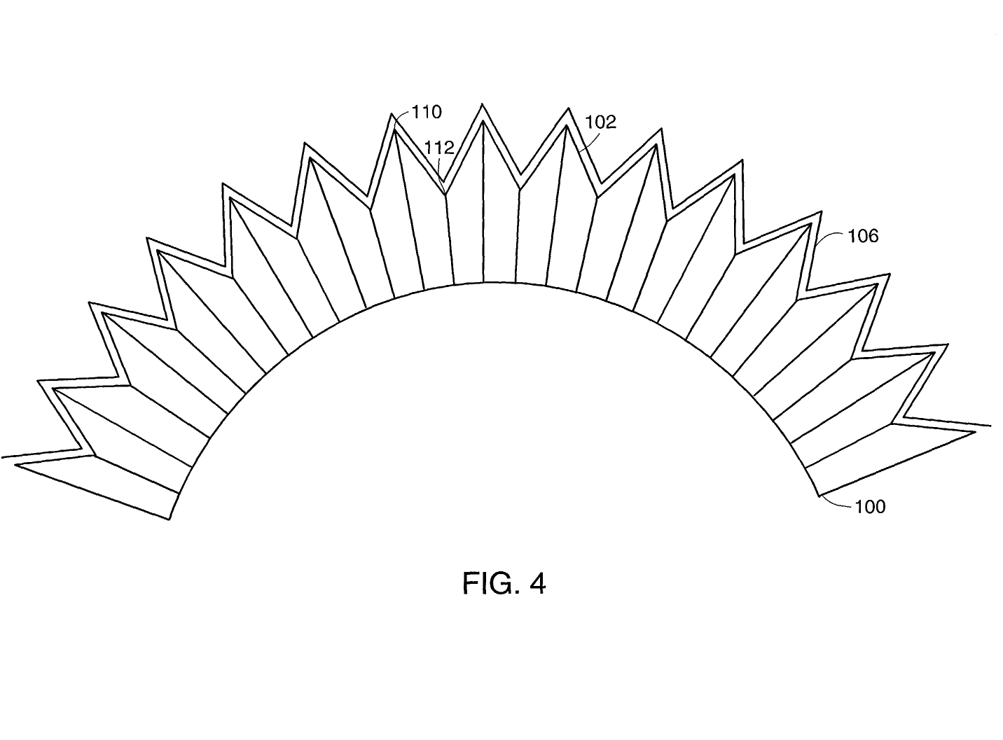

Referring to FIG. 4, shown is a partial cross-sectional view of one embodiment of the drum 100 of the present invention. The drum 100 has a contoured outer surface 102 that has the shape of alternating peaks 110 and valleys 112. The contoured outer surface 102 is covered by the microporous layer 106. As will be further shown, the contoured outer surface 102 with alternating peaks 110 and valleys 112 can be used to form pleated-shaped non-woven articles useful as particulate air filters.

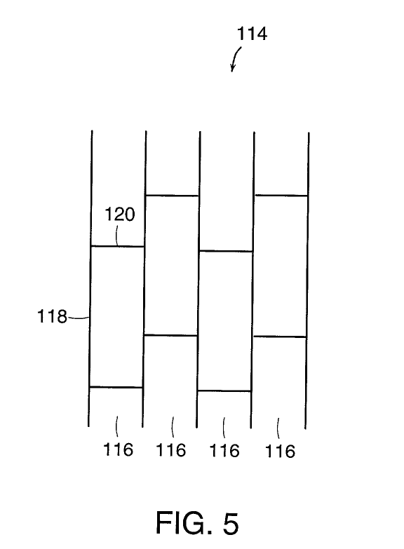

Referring to FIG. 5, shown is a partial radial view of a portion of the drum 100 illustrating a rectangular mesh 114 of tubular honeycomb member 104. The mesh 114 consists of alternating multiple rows of mesh holes 116, where each row is offset from the previous row. Each mesh hole has a length 118 and width 120. In one embodiment the mesh hole length 118 is about 0.5 inches (1.3 cm) and the width 120 is about 0.25 inches (0.64 cm). By using a rectangular mesh 114, the honeycomb member 104 can be readily formed into a circular contour.

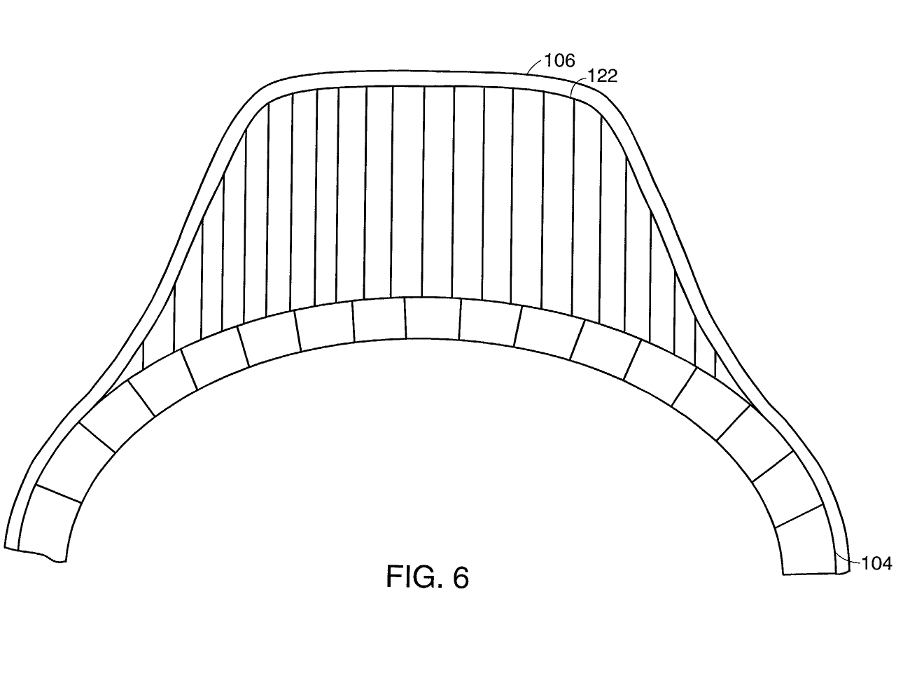

Referring to FIG. 6, shown is another partial cross-sectional view of the drum 100 illustrating a three dimensional form 122 that is attached (e.g., tack-welded) to the drum 100. The three-dimensional form 122 also has honeycomb construction and can be formed by, but not limited to, electrical discharge machining. The three-dimensional form 122 is also covered by the microporous layer 106. As will be further shown, the three-dimensional form 122 can be used to make, for example, a surgical mask shaped article.

FIG. 7 shows one process for manufacturing contoured non-woven articles. Thermoplastic forming polymer 150 is placed in an extruder 152 and passed through a linear die 154 containing about twenty to forty or more small orifices 156 per inch of die 154 width. Convergent streams of hot air 158 rapidly attenuate the extruded liquid polymer 160 to form solidifying filaments 162. The solidifying filaments 162 subsequently get blown by high velocity air 163 onto the contoured outer surface 102 of drum 100. Note that the method illustrated in FIG. 7 for generating the solidifying filaments 162 is a melt blown process, but a spunbonded process, or any other method for generating the solidifying filaments 162 can be used, such as electro-spinning of nano-fibers using an electrostatic spun technique. Melt blown process equipment is available from Biax Fiberfilm Corporation located in Wisconsin.

The drum 100, which is rotating, has a contoured outer surface 102, which can have a combination of shapes, for example, alternating peaks 110 and valleys 112 or a series of three dimensional forms 122. Once the solidifying filaments 162 are deposited on the drum 100, a vacuum or negative pressure 75 can be applied to a portion of the drum 100 to conform the solidifying filaments 162 to the contoured outer surface 102, to prepare closely matching contoured non-woven materials 164.

After the contoured non-woven materials 164 are formed, the rotating drum 100 rotates to a point where the contoured non-woven materials 164 are removed from the drum 100. Positive pressure 79 can optionally be applied through a portion of the drum 100 to facilitate removing the contoured non-woven materials 164 from the drum 100. Once off the drum 100, the contoured non-woven material 164 can be post processed in a variety of post processing operations, for example by application of a spray 165. The treatment can consist of adding various supplements such as flame retardents, stain repellents, colored dyes, and the like, or to change the shape, feel, texture, or appearance of the contoured non-woven material 164.

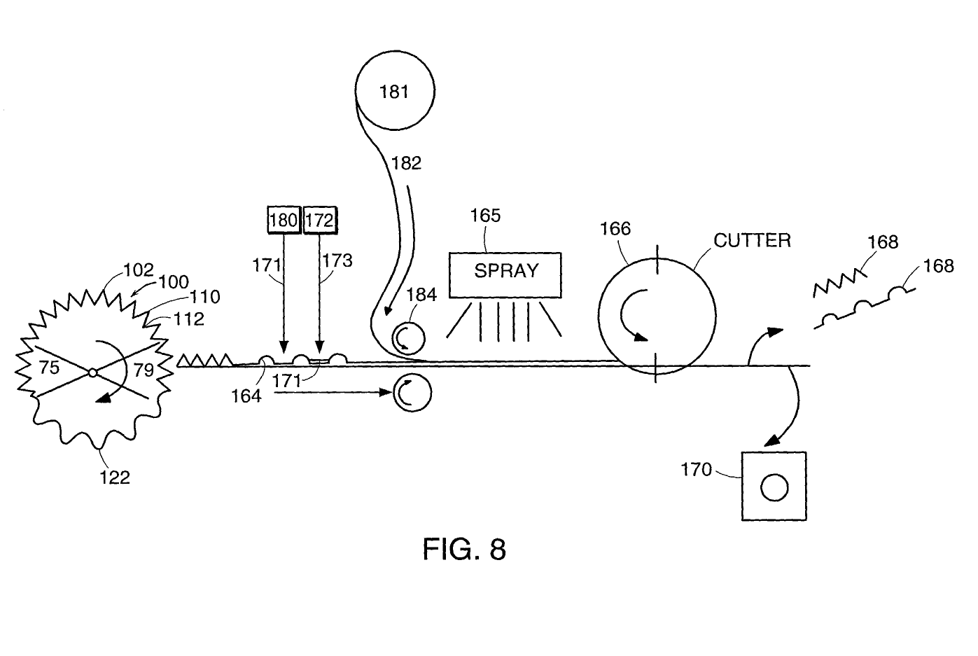

FIG. 8 is an expanded view of additional optional post processing performed on the contoured non-woven material 164. In addition to the treatment operations discussed above, a first material 171 may be added to the contoured non-woven material 164 in order to achieve desired properties in a final product 168. The first material 171 may be a non-woven material or any other material, based on properties required in the final product 168. For example, some materials that can be used for the first material 171 are absorbent substances or charcoal or other filter materials known to those skilled in the art. The first material 171 may be selected based on desired material properties such as pore size, fiber diameter and length, basis weight, and density.

FIG. 8 shows a process step 180 for adding the first material 171 to the contoured non-woven material 164. The process 180 for adding the first material 171 to the contoured non-woven material 164 may be a spunbonded process or a melt blown process for non-woven materials. Alternatively, loose fill or preformed sheet goods, with or without an adhesive treatment, can be deposited on the non-woven material 164. If the first material 171 is a material other than a non-woven material, a person skilled in the art can choose the appropriate method for manufacturing the desired material. An additional process 172 can add a second different material 173 on top of the first material 171. The same considerations used to select the first material 171 can be used to select the second material 173.

A covering material 182 from a source 181 may be placed over the contoured non-woven material 164. The covering material 182 captures or retains the first material 171 and the optional second material 173 within the contoured non-woven material 164. Some materials that may be used for the covering material 182 are organic fibers, inorganic fibers, and polymers, which can be in the form of woven or non-woven sheet goods, films, and the like, and which may or may not be porous. The covering material 182 may be adhered or bonded to the contoured non-woven material 164 by a variety of processes 184 known to those skilled in the art, such as a pair of rollers, a heated die, etc. to seal and/or laminate the layers. Additional layers of materials and coverings may be applied, as desired.

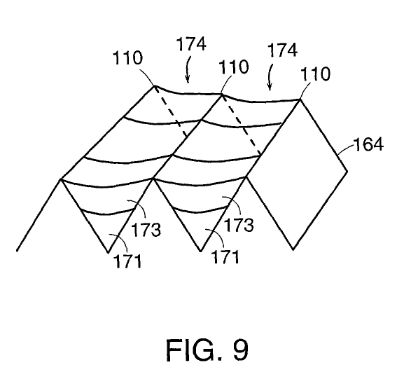

FIG. 9 illustrates the presence of the first material 171 and the second material 173 in the valleys of a pleated contoured non-woven material 164. The first material 171 and the second material 173 effectively bridge 174 the peaks 110 in the pleated material 164. The bridge 174 may be made up of just the first material 171, a combination of the first material 171 and the second material 173, or a plurality of different desired materials. The bridge 174 may bridge or partially or fully fill any three dimensional contour.

The process of FIG. 8 results in a wide variety of articles which can be used in a variety of applications. One embodiment resulting from the process of FIG. 8 consists of a non-woven material 164, where the first material 171 added is a carbon filtration material and a covering material is applied overall. Another embodiment consists of a non-woven material 164, where the material added results in a varying gradient filter article. The varying gradient filter article has multiple filter layers. Each layer can have its own filter pore size. Each layer in the varying gradient filter article can trap different particle sizes. In addition, another embodiment of the process of FIG. 8 consists of a non-woven material 164, where the first material 171 added can be a high loft material, so that the resultant article can be used for absorption of oil or other liquid. Other materials can be selected by a person skilled in the art, based on the particular application and performance sought.

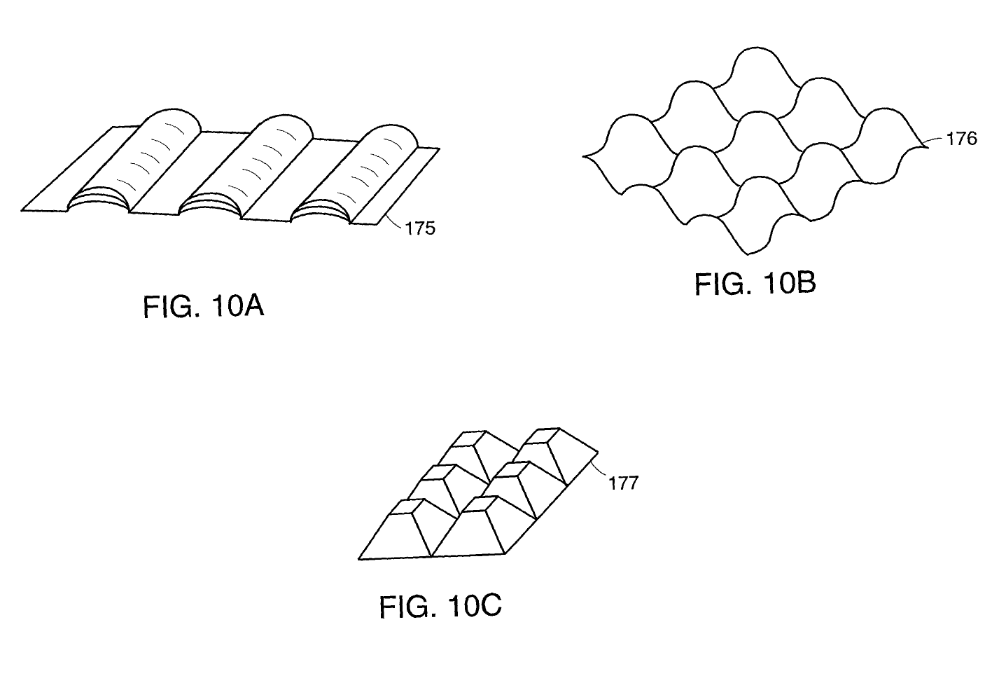

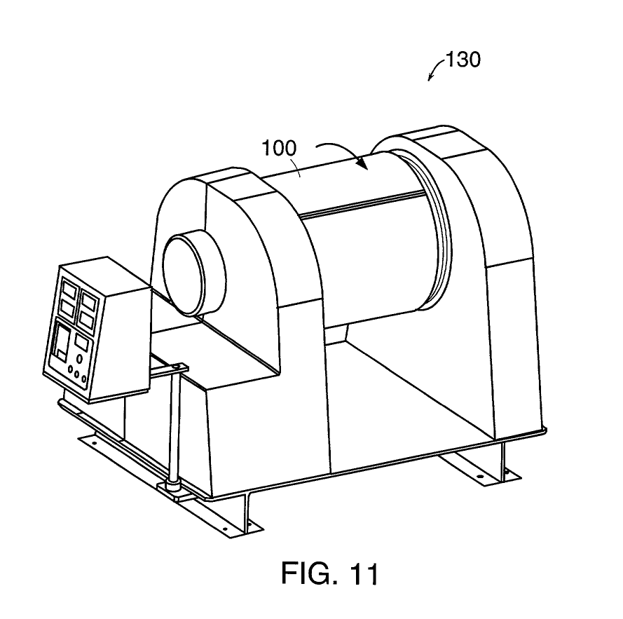

FIGS. 10A-10C show additional three dimensional contours which can be manufactured by the process, such as half tube 175, multinodal 176, and pyramidal or frustoconical 177 contours. Other contours, both regular and irregular, will be apparent to those skilled in the art based on the teachings herein.

Referring back to FIG. 7, after any post processing has been completed, the contoured non-woven material 164 may pass through a cutter 166, to cut the contoured non-woven material 164 into the desired article or final product 168. The cutter 166 may be a die, water jet, laser, or any other apparatus capable of trimming to the desired contour. Any waste 170 after the cutting operation can either be disposed of or recycled. Accordingly, non-woven contoured articles such as wipes, filters, face masks, sorbent products, insulation, clothing, and the like can be rapidly produced from polypropylene, polyester, or other materials in a continuous process at low cost.

While an open, apertured inner tube 70, such as that depicted in FIG. 3B, may be used in a variety of applications with good results, it may be desirable to better control the pressure and/or flow across the drum 100 by using an internal manifold with adjustable features and low losses. Accordingly, the amount of suction or pressure applied to the material deposited on the drum can be tailored for the particular material, density, contour, etc.

Referring to FIG. 11, shown is an embodiment of an apparatus 130 for the manufacture of non-woven articles. The apparatus 130 includes a rotatable honeycomb drum 100. The drum 100 can have a contoured surface, as discussed hereinabove, and have an adjustable manifold disposed therein.

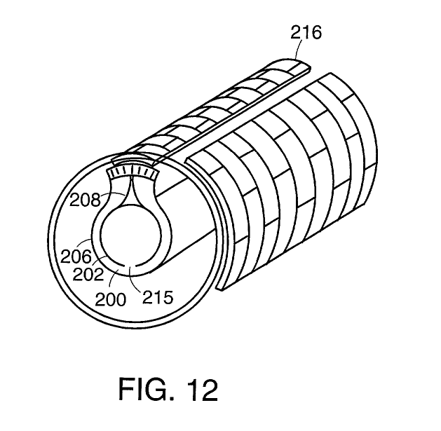

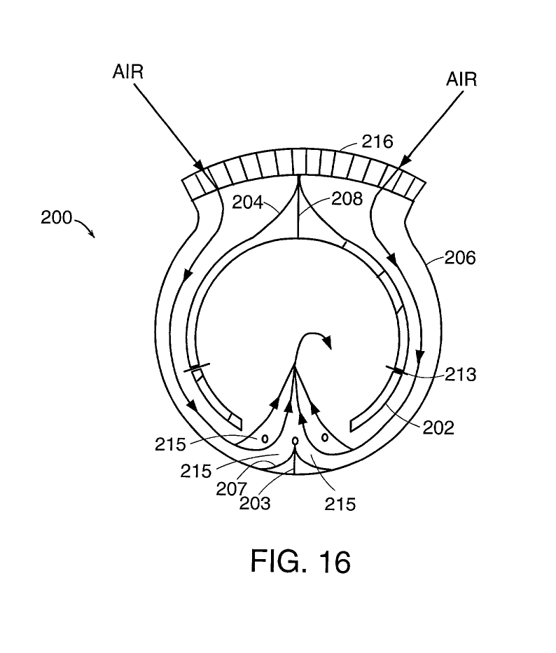

Referring to FIG. 12, shown is an embodiment of a manifold tube assembly 200 for controlling flow in the drum 100, solely a portion of which is depicted. The tube assembly 200 includes an inner tube 202 and a vacuum shell 206. Either vacuum or pressure may be applied to the drum 100. The tube assembly 200 defines an air flow path inside the drum 100. The air flow path passes through a honeycomb panel 216, past a partition top 208, along a channel formed between the inner tube 202 and the vacuum shell 206, through port 215, and inner tube 202. See FIG. 16. Air may flow into or out of the manifold 200 and the drum 100 along the flow path defined above, depending on whether vacuum or pressure is applied to the inner tube 202.

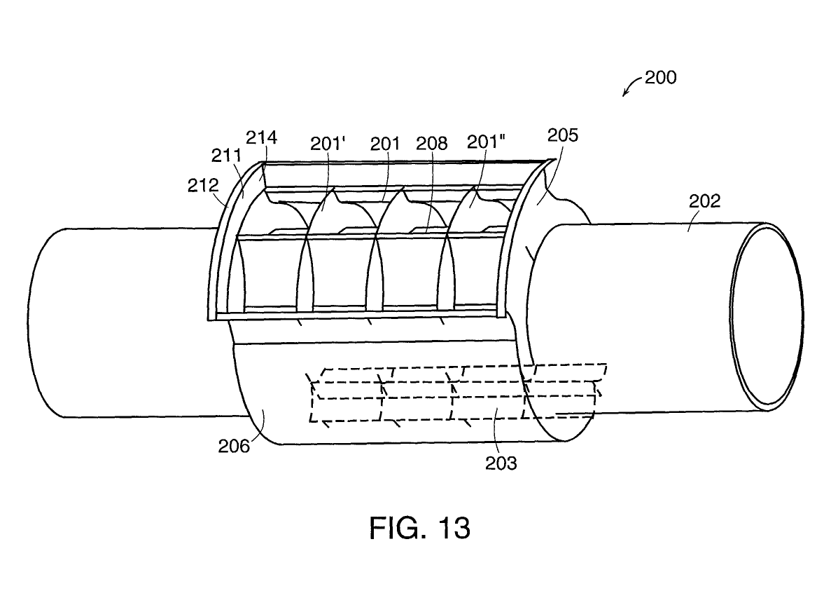

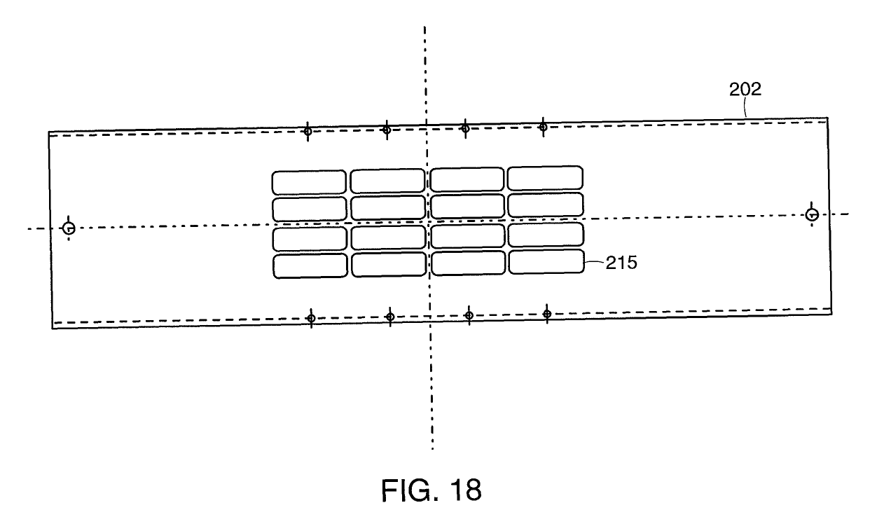

Referring to FIG. 13, shown is a perspective view of an embodiment of the inner tube 202 and vacuum shell 206 of the manifold 200. The inner tube 202 passes through the vacuum shell 206. The vacuum shell 206 has a partitioned bottom 203 to direct air through a plurality of ports 215 of inner tube 202 to allow air to pass into or out of the inner tube 202. See FIG. 18. The vacuum shell 216 includes a vacuum plate 205 at each end sealed to the inner tube 202 to prevent air from leaking around the inner tube 202. A honeycomb panel 216 can be mounted within vacuum frame 211, as shown in FIG. 24, to provide a uniform distribution of air flow through the vacuum shell 206.

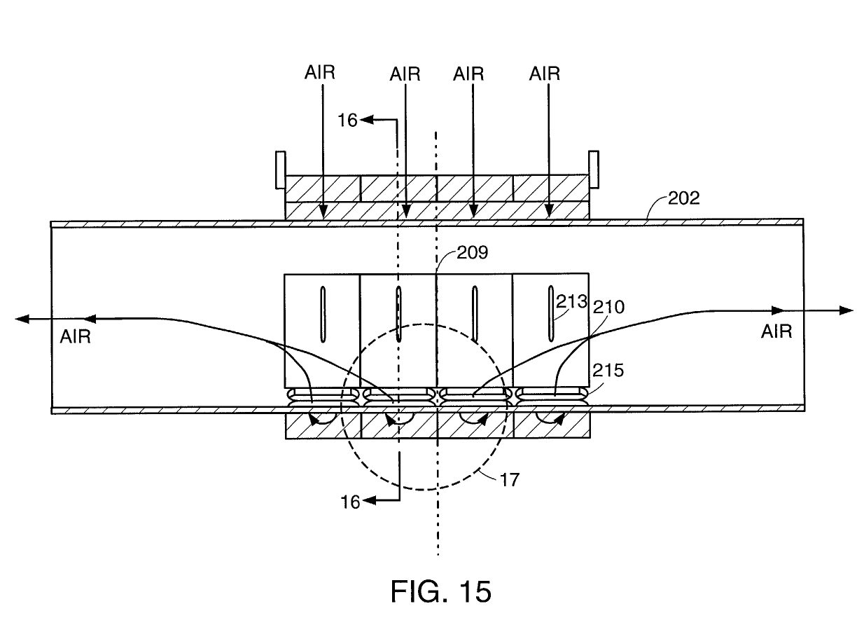

FIG. 13 shows the vacuum shell 206 is split into left and right halves by a center ring partition 201 and along its longitudinal axis by top partition 208 and bottom partition 203. FIG. 15 shows each side or half can be balanced for airflow via a plurality of gate valves 210, which can be adjusted independently to uncover, partially cover, or fully cover the ports 215. The double tube arrangement (inner tube 202 within vacuum shell 206) is used to provide tailored airflow without the use of a plurality of separate pipes. The double tube configuration of the manifold 200 also provides an efficient method for redirecting airflow from a radial to an axial direction.

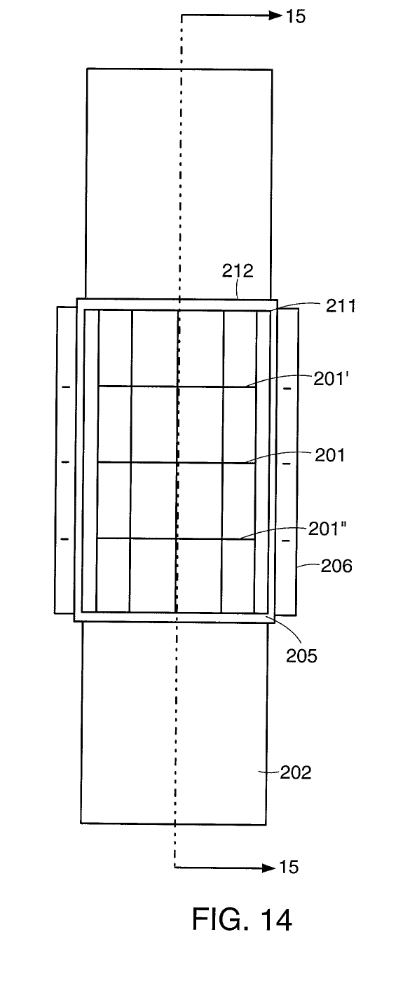

FIG. 14 shows a view of the inner tube 202 and vacuum shell 206 viewed through the vacuum frame 211. This view illustrates the center ring 201 for dividing the air flow at a midpoint of the inner tube 202 and the drum 100. Two additional rings 201′, 201″ are depicted, which further subdivide the vacuum frame opening into eighths.

Referring to FIG. 15, shown is a partial cross-sectional view of the inner tube taken along line 15-15 in FIG. 14. FIG. 15 illustrates one embodiment for controlling the flow of air in the drum. Gates 210 can be moved over ports 215 to modify the flow of air into or out of inner tube 202. In one embodiment, the gates 210 are slotted and can be attached to the inner tube 202 by screws 213.

Referring to FIG. 16, shown is a partial cross-sectional view of the inner tube 202 and vacuum shell 206 along line 16-16 in FIG. 15. FIG. 16 illustrates the flow path of air drawn through the drum 100 and into the manifold 200. For descriptive purposes only, a vacuum flow through the drum is described, but the path can be reversed to apply a pressure to the drum to facilitate removing a non-woven article formed thereon. Air is drawn through the outer drum honeycomb assembly (not shown), through the honeycomb panel 216, into an annular channel formed between the vacuum shell 206 and the inner tube 202, and then into the inner tube 202 through ports 215. FIG. 16 also shows once the air is in the inner tube 202, air is drawn out of the inner tube through one or more openings at the ends of the inner tube 202.

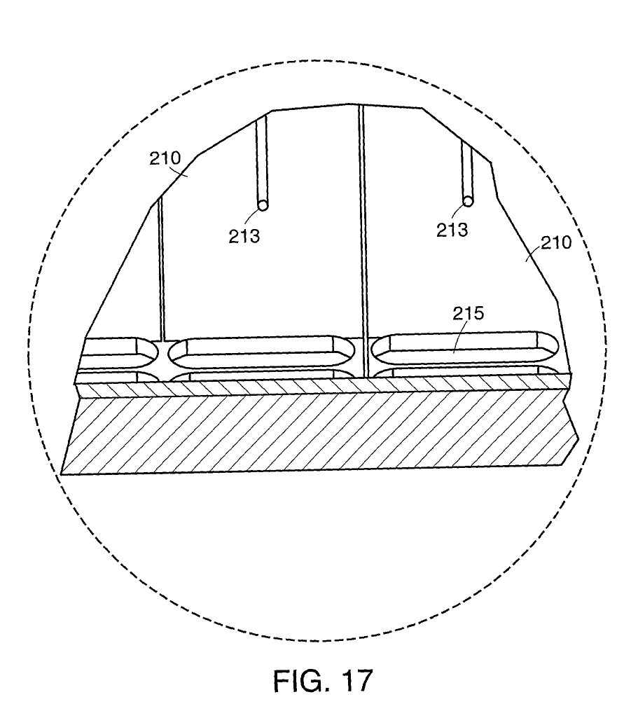

FIG. 17 is an exploded view of Detail 17 in FIG. 15 to illustrate the relationship between the ports 215, gates 210, and screws 213. As may be readily understood, by subdividing the vacuum tube assembly into a plurality of zones, with airflow paths independently controllable using the gates 210, vacuum or pressure applied to various zones of the drum passing thereover can be tailored to achieve a desired result.

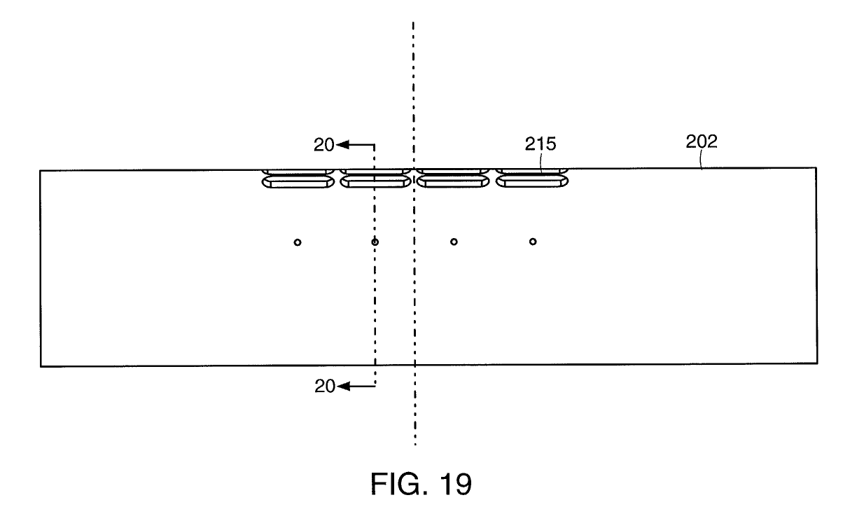

FIG. 18 is a bottom view of the inner tube 202 showing the ports 215 in the inner tube 202 which allow air to pass into or out of the inner tube 202. This embodiment employs sixteen ports 215. FIG. 19 is a side view of inner tube 202.

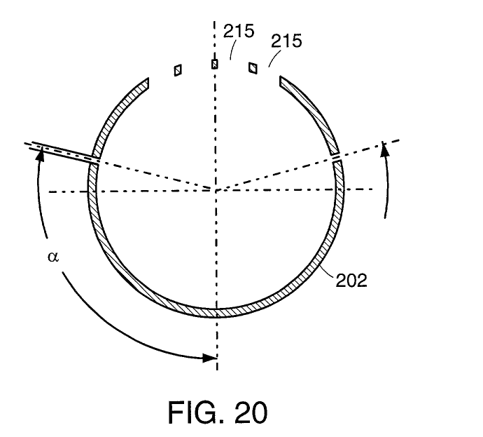

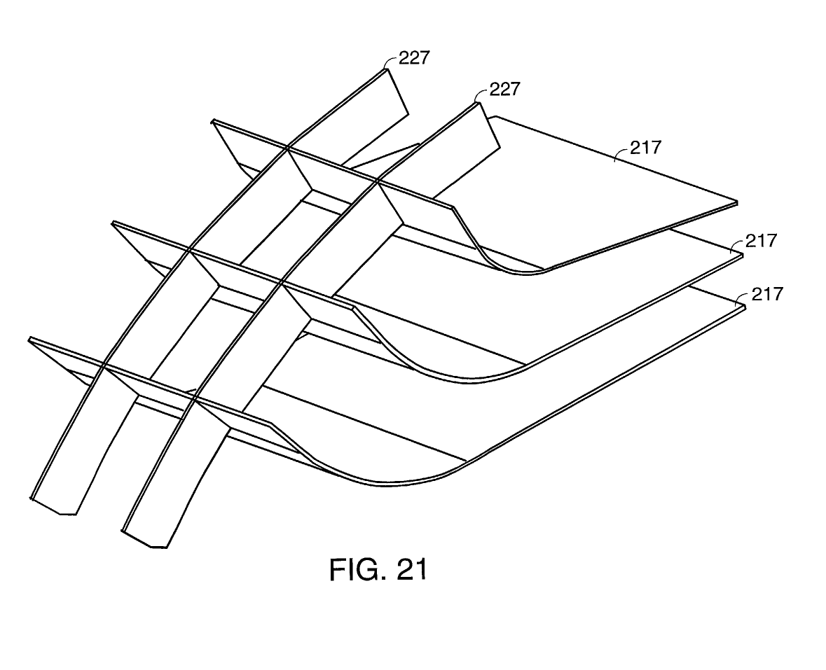

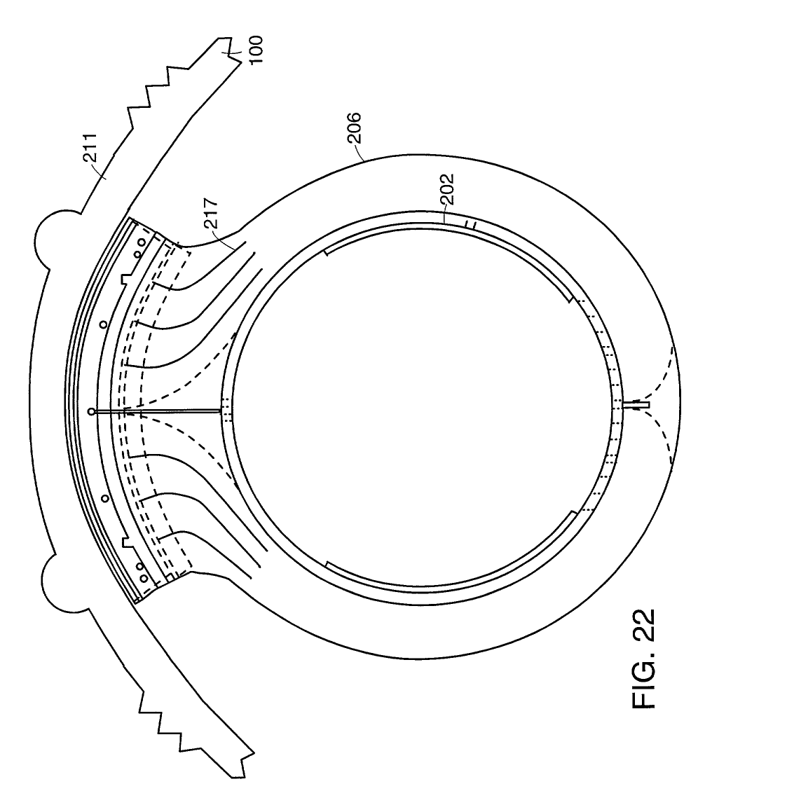

Referring to FIG. 20, shown is a view along cross-section 20-20 of the inner tube 202 of FIG. 19. Tapped holes for the gate screws 213 may be located for convenient access to facilitate adjustment of the gates 210. In this embodiment, they may be located at an angle a of about 100° to about 110°, although any location can be selected.

Referring back to FIG. 13, the vacuum shell 206 is split into left and right halves by a center ring portion 201 and along its longitudinal axis by top partition 208 and bottom partition 203. FIG. 13 shows an embodiment where the vacuum shell 206 is divided by similar rings 201′, 201″ which are parallel to the outer ring, further subdividing the shell 206 into multiple compartments. In this embodiment, there are eight compartments so formed. Each compartment can be balanced for airflow volume via a separate gate valve 210 which can be adjusted to uncover, partially cover, or fully cover two ports 215. In addition, the efficiency of airflow in each compartment can be enhanced and losses reduced by using optional flow turning vanes 217.

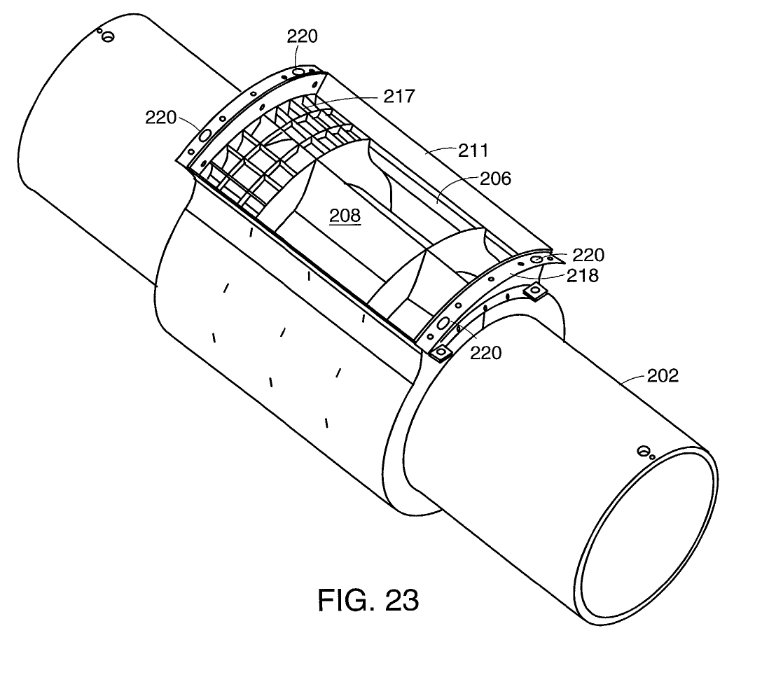

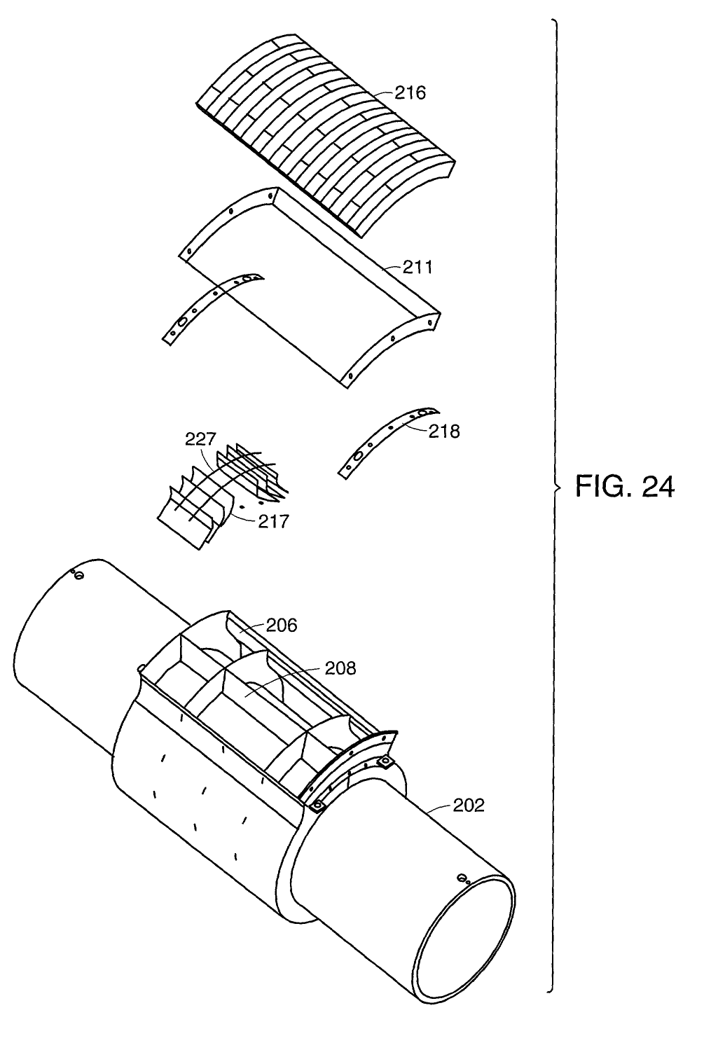

FIG. 21 shows a perspective view of the flow turning vanes 217 used in each compartment. Rails 227 are connected to leading edges of the flow turning vanes 217 to hold the flow turning vanes 217 together. The flow turning vanes 217 are then placed on the top partition 208 as best seen in FIG. 23. Once the flow turning vanes are placed on the top partition 208, the downstream edges of the flow turning vanes 227 are suspended in the annular channel between the inner tube 202 and the vacuum shell 206. By altering the distance between the downstream edges the airflow speed may be altered over the entire surface covered by the vanes 217.

FIG. 22 is a side view of the inner tube 202 and the vacuum shell 206 which shows the position of the flow turning vanes 217 in the annular channel between the inner tube 202 and the vacuum shell 206. FIG. 22 also shows the relationship between the manifold 200 and the drum 100. Note that only a section of the drum 100 is shown in FIG. 22.

FIG. 23 is a perspective view of two sets of the vanes 217 installed in two of the compartments of the manifold 200 and FIG. 24 is an exploded view. Vanes 217 can be used in all, some, or none of the compartments and can be of similar or different number and configuration, depending on the particular application and desired results. In the assembly, the flow turning vanes 217 and rails 227 are placed on the top partition 208. Then the frame 211 is mounted to the vacuum shell 206. Brackets 218 are then screwed on to the vacuum shell 206 to constrain the frame 211. Screws 222 to attach the frame 211 to the vacuum shell 206 run through holes 220 in the brackets 218. Finally, an optional honeycomb panel 216 is placed inside the frame 211. The height of the honeycomb 216 relative to the turning vanes 217 can be adjusted.

The double arrangement of the inner tube 202 within the vacuum shell 206, coupled with the flow turning vanes 217 and gate valves 210, are used to provide tailored air flow on the honeycomb panel 216 and, accordingly, through the drum 100, in both machine direction and cross direction. The double arrangement of the inner tube 202 within the vacuum shell 206, coupled with the turning vanes 217, also provides a method for redirecting airflow from a radial to an axial direction efficiently.

The following detailed description relates to a method and apparatus for use with a honeycomb drum and a through-air bonding apparatus for forming non-woven articles. The method and apparatus provide a hot air flow through non-woven articles being formed on the drum which bonds the non-woven articles internally, without the use of compression rollers or heated calender rollers.

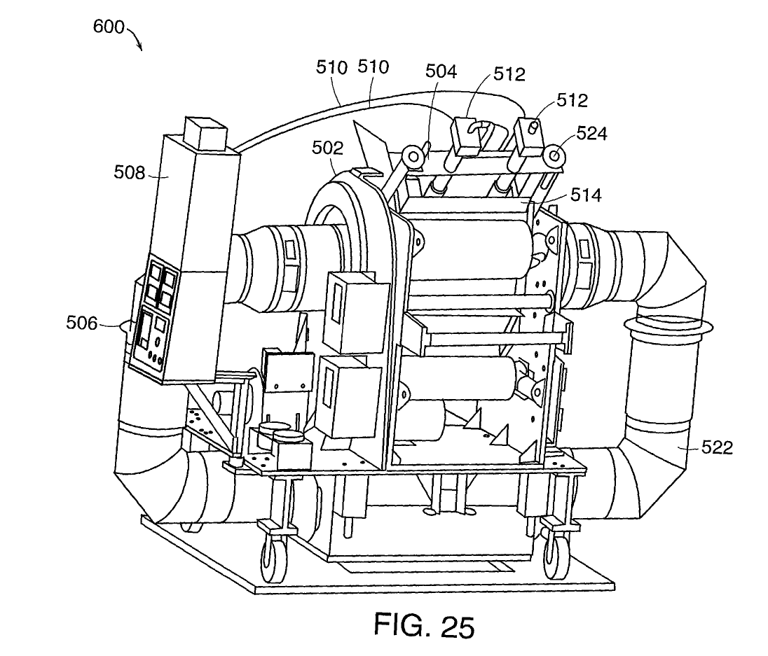

Referring to FIG. 25, shown is an embodiment of an apparatus 600 for the manufacture of non-woven articles. The apparatus 600 includes a rotatable honeycomb drum 502. The drum 502 can have a contoured outer surface, as discussed above. In addition, the apparatus 600 also includes a through-air bonding apparatus 504.

The apparatus 600 includes a drum control unit 506 to control the movement of the drum 502 and a hot air control unit 508 to control the temperature, pressure, and volume of air to be used to internally bond and consolidate non-woven articles formed on the drum 502. Air is supplied from an air source to the hot air control unit 508 and then conveyed to the through-air bonding system 504 through one or more pipes 510. In one embodiment, unheated air can be supplied to the through-air bonding apparatus 504. The air can be heated by one or more heaters 512 attached to the through-air bonding apparatus 504. Heated air is then fed to a manifold 514 in the through-air bonding apparatus 504.

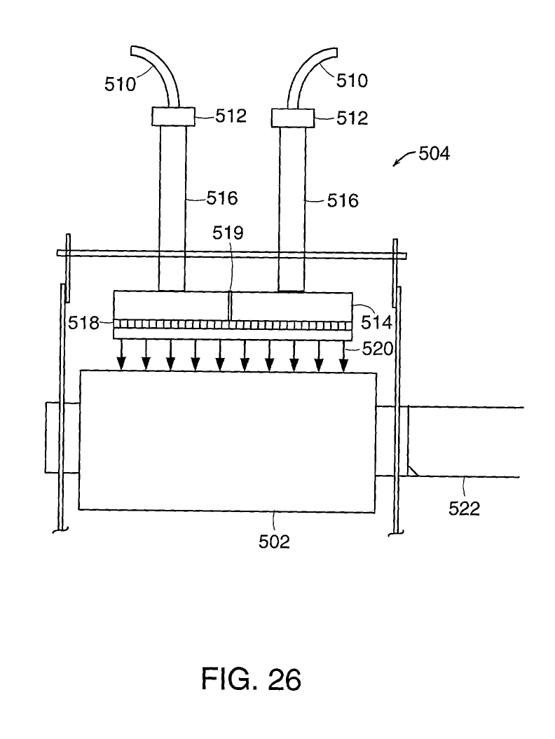

Referring to FIG. 26, shown is an embodiment of the drum 502 and manifold 514 of the through-air bonding apparatus 504. The air is fed from pipes 510 to heaters 512 to heat the air. Heated air is fed by pipes 516 to the manifold 514. The manifold 514 generally include a flow control honeycomb structure 518 to provide a uniform distribution of the heated air to the drum 502. The manifold 514 also includes a centrally located internal manifold compartment bulkhead 519 and optionally can include further bulkheads, turning vanes, etc. to provide a more uniform or tailored distribution of heated air. The controlled distribution of heated air results in predetermined consolidation of non-woven materials formed on the drum 502. Using a tailored distribution of heated air to achieve predetermined consolidation of non-woven materials can be important in forming non-woven materials with three-dimensional shapes. Heated air exits the manifold 514 through manifold aperture 520. As disclosed in the above-referenced patents, a vacuum can be drawn through the drum 502. The heated air exiting the aperture 520 can be drawn through the non-woven material and the drum 502 and out through the center of the drum through air duct 522.

Referring back to FIG. 25, the air duct 522 is used to return the air back to the air source. The apparatus of FIG. 25 also includes an aperture height adjustment 524 to adjust the height or standoff of the aperture 520 relative to the drum 502.

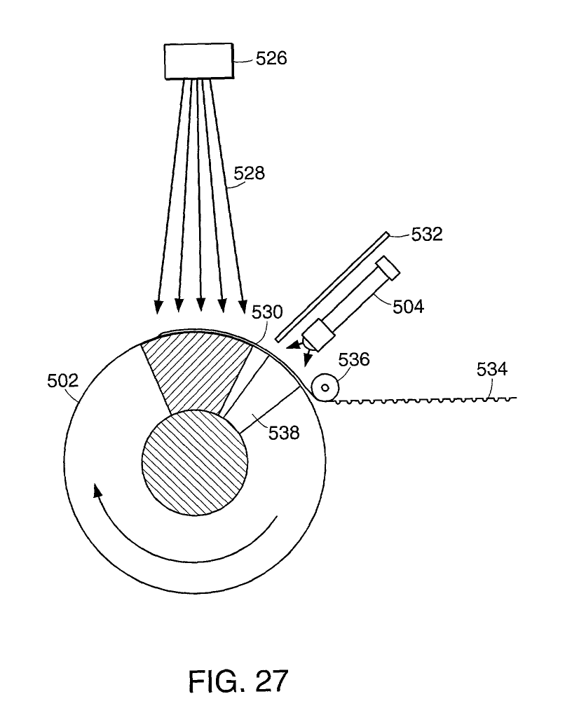

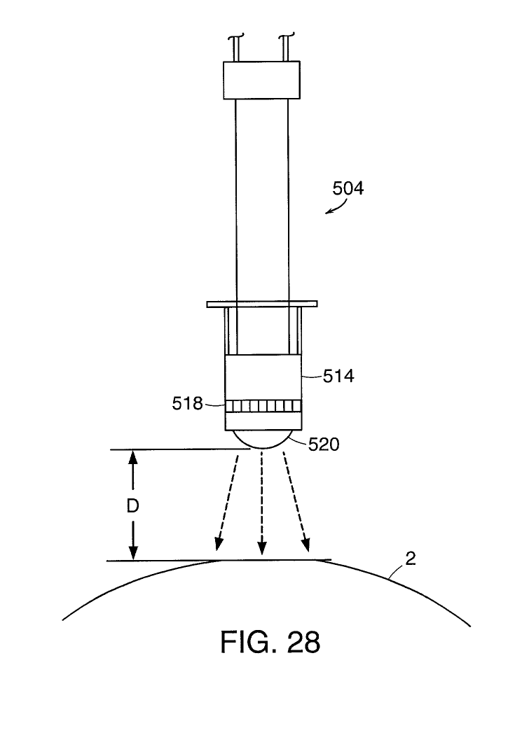

FIG. 27 shows one embodiment of the drum 502 and through-air bonding apparatus 504 which uses a spun bond method for creating a non-woven web; however, melt blown, electro spinning of nano-fibers, or other methods of making a non-woven webs known to those skilled in the art can be used.

A spinneret 526 generates a series of solidifying filaments or fibers 528 which form a non-woven web 530 on drum 502. Note that a belt can be used in place of the drum 502. The drum 502 then moves the non-woven web 530 past a separation panel 532 and passes the non-woven web 530 under the through-air bonding apparatus 504. The separation panel 532 isolates the newly formed non-woven web 530 from hot air until the non-woven web 530 is positioned under the through-air bonding apparatus 504.

Prior to applying hot air, the non-woven fibers 528 from the spunbound process which form the non-woven web 530 and can easily be pulled apart. At this point the non-woven web 530 does not have enough structural integrity to be passed from the drum 502 to a web transfer roll 536. A through-air bonding process applies hot air from the through-air bonding apparatus 504 to the non-woven web 530 to achieve an internally bonded, consolidated non-woven material 534.

After the hot air passes through the non-woven material 530, the hot air is drawn into the drum 502 through a vacuum or hot air collection system 538 in the drum 502. The hot air then passes to air ducts 522 which return the air back to the air source.

The amount of bonding provided to the non-woven material can be adjusted by changing the temperature of the air, the distance of the aperture 520 supplying the air relative to the drum 502, the velocity of the air, and the volume of air. The amount of bonding can be set to achieve a desired material property in the non-woven material. Some material properties that can be affected by the amount of bonding are the softness and drape of the non-woven material. The drape of the non-woven material is the ability of a non-woven material to fold onto itself and conform to the shape of an article it covers.

In addition, the amount of bonding applied to the non-woven material 530 can be set to provide enough structural integrity to eliminate the need for compression rollers and heated calender rollers used in the prior art to provide structural integrity to the non-woven web 530. By eliminating the use of compression rollers and heated calender rollers, the resulting internally bonded non-woven material 534 has more loft than if the heated calender rolls and compression rollers were used. However, if one desires to have certain non-woven material properties associated with the use of calender rolls, such as strength or compaction, a calender roll may be added downstream from the through-air bonding apparatus 504.

After passing under the through-air bonding apparatus 504, the bonded non-woven material 534 is transferred to a web transfer roll 536. Then the bonded non-woven material 534 can be post-processed as discussed above.

Referring to FIG. 28, shown is an embodiment of the manifold 514 and drum 502. FIG. 28 shows dimension D, which represents the height of the aperture 520 in the manifold 514 relative to the drum 502. The height D can be adjusted by the height adjustment mechanism 524 shown in FIG. 25, using twin screws. By adjusting the height D, the amount of bonding of the non-woven material 530 can be modified to achieve a desire material property in the bonded non-woven material 534.

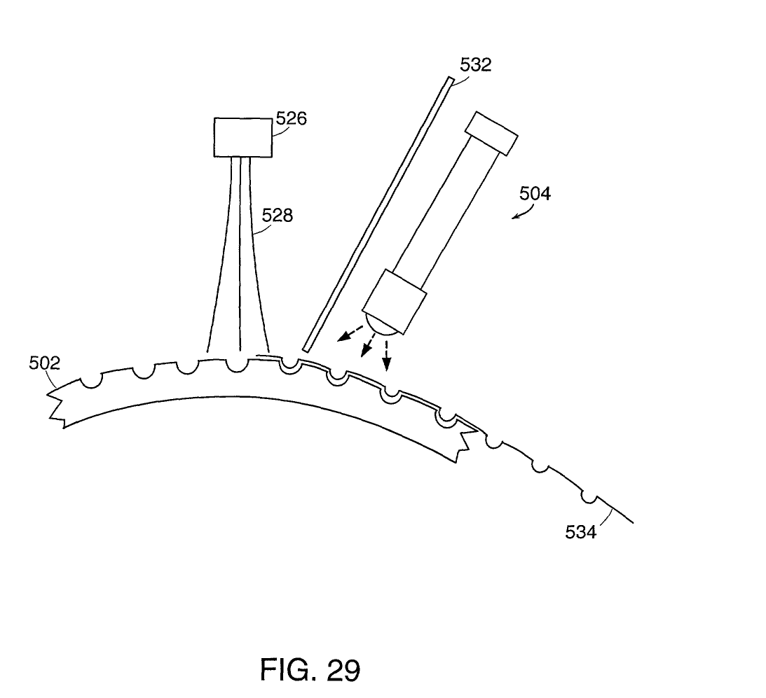

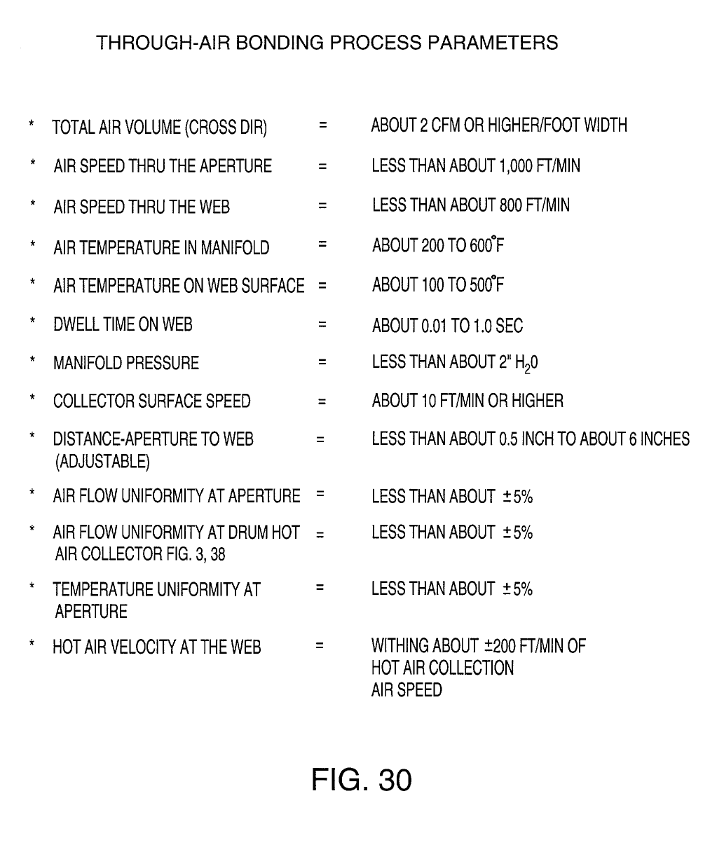

FIG. 29 illustrates an embodiment of the drum 502 and the through-air bonding apparatus 504 where the drum 502 has three-dimensional contours. The three-dimensional contours on the drum 502 allow a non-woven article with a three-dimensional shape to be formed using the methods described above. By using through-air bonding, this allows bonded non-woven materials 534 with three-dimensional shapes to be bonded without the use of compression rollers or heated calender rolls. Bonding non-woven materials with three-dimensional shapes without the use of compression rollers or heated calender rolls allows the non-woven material to maintain its three-dimensional shape.

FIG. 30 is a table showing typical ranges of process parameters in accordance with the current invention.

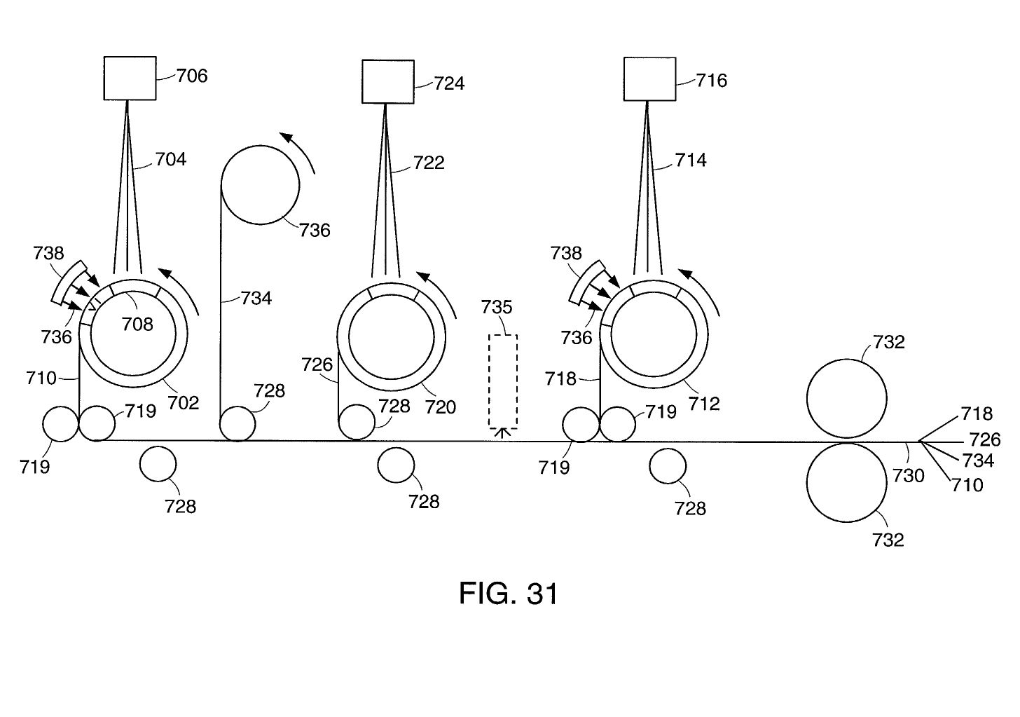

A multi-drum system may be employed to improve multi-layered web uniformity and the overall quality of the non-woven product by presenting a single optimal collection surface for each independent web layer being produced. In FIG. 31, a first drum 702 is shown collecting solidifying fibers 704 from a spunbond spinneret 706. A vacuum port 708 on the drum 702 may be “air flow balanced” as previously described and, by design, presents an optimum condition to the fibers for formation of the spunbond layer of the web 710. Each subsequent drum similarly provides an optimum condition for producing one or more additional spunbond and/or meltblown layers. FIG. 31 also shows drum 712 collecting solidifying fibers 714 from spunbond spinneret 716 to form a second spunbond layer 718. Spunbond layers 710 and 718 may be passed through respective nip rollers 719. In addition, also shown in FIG. 31 is drum 720 collecting solidifying fibers 722 from a melt blown source 724 to form meltblown layer 726. Each web layer is then independently distributed to the transport system 728 for incorporation and consolidation into the multi-layered web 730. In one embodiment, the transport system 728 can be a travelling belt. The multi-layered web 730 can be calendared with calendar rolls 732, if desired.

Optionally, other roll goods may be distributed into the multi-layered web 730, such as a thin polymer film 734, shown in FIG. 31. Similarly, other optional processes may be incorporated “in line,” such as bonding or finishing, shown as post processing apparatus 735. In the embodiment shown in FIG. 31, the multi-layer web 730 is made from spunbond layers 710 and 718, meltblown layer 726, and film layer 734.

Through-air bonding of the web can be advantageously employed on one or more of the drums in order to provide bonding, strength, and integrity to the various layers of the web. As previously described, heated air 736 is applied, through a manifold 738, over a wide area of the web, in order to cause a softening and/or slight melting of the individual fibers. The fibers are fused together at the points where they touch or contact each other, causing a permanent bond joint. If desired, the fibers may be specially manufactured to improve the bonding conditions. This may include the use of bicomponent fibers, such as a polypropylene material core sheathed with polyester material, or a “side-by-side” configuration of polypropylene and polyester fibers. This technique takes advantage of the lower melting point of the second component fiber, enhancing the bond condition.

Multi-zone thru-air ovens may be used for highloft bonding of the web at low speeds. Heated air is applied to the spunbond layer of the web, as it is newly formed on the surface of a drum. The spunbond layer is thereby provided with enough structural integrity to be unwound from the drum, for post processing, or for introduction of the spunbond layer into a multi-layered web structure. In this manner, the web can be processed at very high speeds utilizing through-air bonding on a drum collector. For a description of thermal bonding methods, refer to web page entitled “Thermal bonding processes,” found at address http://www.nonwovens.com/facts/technology/bonding/thermal.htm, the disclosure of which is incorporated herein in its entirety by reference.

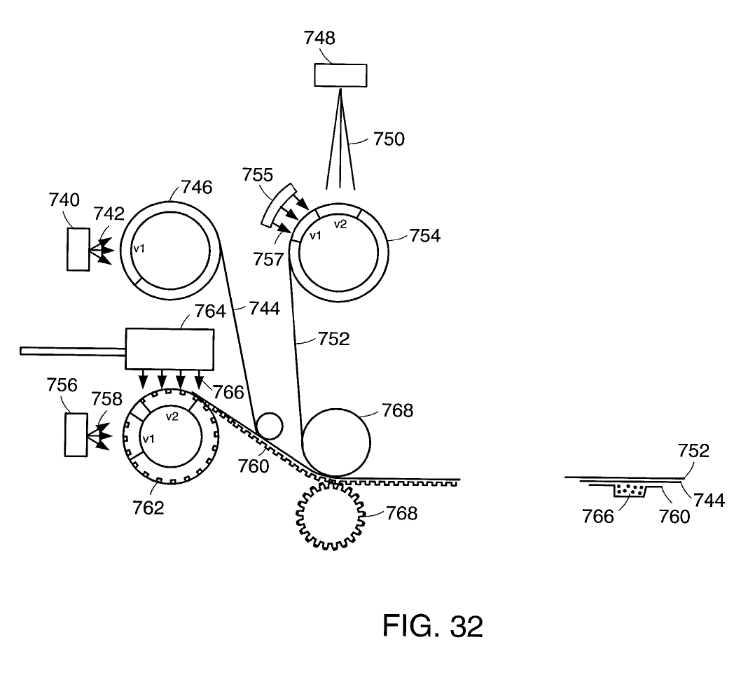

In the “stacked drum” configuration shown in FIG. 32, other processes are shown being accommodated. In this embodiment, a meltblown process is combined with a spunbond process and a 3-D meltblown process, in accordance with the description hereinabove. The meltblown process uses meltblown fiber source 740 to provide meltblown fibers 742 to form a meltblown web 744 on drum 746. The spunbond process uses spunbond fiber source 748 to provide spunbond fibers 750 to form spunbond web 752 on drum 754. Manifold 755 can be used to supply heated air 757 to cause a softening or slight melting of the fibers. The 3-D meltblown process uses meltblown fiber source 756 to provide meltblown fibers 758 to form contoured meltblown web 760 on contoured drum 762. Further, an optional dispenser 764 distributes materials 766 such as cellulose, carbon, filtration, superabsorbent, or other materials into the 3-D shapes to produce a filled layered web. Superabsorbent materials are also known as superabsorbent particles or SAP. Superabsorbent materials are disclosed in U.S. Pat. No. 5,064,653, the contents of which are incorporated by reference in its entirety. Typical superabsorbent materials include sodium and aluminum salts of starch grafted copolymers of acrylates and acrylamides and combinations thereof, as well as polyacrylate salts. A film layer, impervious to the flow of liquids therethrough, may optionally be added, as desired. Subsequent finishing operations may include bonding with bonding rolls 768 or other treatment of the web to further consolidate or process the multi-layered material.

Many different combinations and permutations of the configurations of the embodiments described above are possible. For example, multiple sources of non-woven fibers could be applied to either different circumferential or axial locations on a drum. In addition, a belt may be used in place of a drum.

Variations, modifications, and other implementations of what is described herein will occur to those of ordinary skill in the art without departing from the spirit and the scope of the invention as claimed. Accordingly, the invention is to be defined not by the preceding illustrative description, but instead by the following claims.

1. An apparatus for forming a multi-layered web, the apparatus comprising:
two drums, each drum comprising a generally tubular honeycomb member having an outer collection surface for forming a non-woven web thereon;
a non-woven fiber source corresponding to each drum; and
a web transport system for forming the multi-layered web from the non-woven webs formed on the drums.

2. The invention according to claim 1 wherein at least one the drums further comprises a microporous layer covering at least a portion of the outer collection surface thereof.

3. The invention according to claim 1 wherein the non-woven fiber sources are selected from the group consisting of a spun-bonding source, an electro spinning nano-fibers source, and a melt blown source.

4. The invention according to claim 1 wherein the apparatus further comprises a through-air bonding apparatus in proximity to at least one of the drums.

5. The invention according to claim 1 wherein the apparatus further comprises a post processing device in proximity to the web transport system.

6. The invention according to claim 1 wherein the apparatus further comprises a film source for providing a film with the multi-layer web.

7. The apparatus of claim 1 wherein at least one of the drums comprises a contoured outer collection surface for forming a contoured non-woven web.

8. The apparatus of claim 7 further comprising a dispenser located proximate the contoured outer collection surface for providing a filler material to the contoured nonwoven web.

9. The apparatus of claim 8 wherein the dispenser dispenses filler material selected from the group consisting of cellulose material, carbon material, filtration material, and superabsorbent material.

10. The invention according to claim 1 wherein at least one of the drums further comprises a flow control device for tailoring flow through the outer collection surface thereof.

11. The invention according to claim 1 wherein the apparatus further comprises calender rolls for calendering the multi-layer web.

12. A method for producing a multi-layer web, the method comprising the steps of:
providing an apparatus comprising:
two drums, each drum comprising a generally tubular honeycomb member having an outer collection surface for forming a non-woven web thereon;
a non-woven fiber source corresponding to each drum; and
a web transport system for forming the multi-layered web from the nonwoven webs formed on the drums,
supplying non-woven fibers from the non-woven fiber sources to the corresponding drums;
forming independently non-woven webs on each outer collection surface of the drums; and
forming the multi-layer web on the web transport system.

13. The method according to claim 12 wherein at least one the drums further comprises a microporous layer covering at least a portion of the outer collection surface thereof.

14. The method according to claim 12 wherein the non-woven fiber sources are selected from the group consisting of a spun-bonding source, an electro spinning nano-fibers source, and a melt blown source.

15. The method according to claim 12 wherein the apparatus further comprises a through-air bonding apparatus in proximity to at least one of the drums.

16. The method according to claim 15 further comprising the step of providing structural integrity to at least one of the non-woven webs using the through-air bonding apparatus.

17. The method according to claim 12 wherein the apparatus further comprises a post processing device in proximity to the web transport system.

18. The method according to claim 17 further comprising the step of post-processing at least one non-woven web.

19. The method according to claim 12 wherein the apparatus further comprises a film source for providing a film with the multi-layer web.

20. The method of claim 19 further comprising the step of adding a film to the multi-layer web.

21. The method according to claim 12 wherein at least one of the drums comprises a contoured outer collection surface for forming a contoured non-woven web.

22. The method according to claim 21 wherein the apparatus further comprises a dispenser located proximate the contoured outer collection surface for providing a filler material to the contoured non-woven web.

23. The method according to claim 22 further comprising the step of adding a filler material to at least one contour in the contoured non-woven web.

24. The method according to claim 22 wherein the dispenser dispenses filler material selected from the group consisting of cellulose material, carbon material, filtration material, and superabsorbent material.

25. The method according to claim 12 wherein at least one of the drums further comprises a flow control device for tailoring flow through the outer collection surface thereof.

26. The method according to claim 25 further comprising the step of tailoring flow through at least one of the drums.

27. The method according to claim 12 wherein the apparatus further comprises calender rolls for calendering the multi-layer web.

28. The method according to claim 27 further comprising the step of calandering the multi-layer web.

29. A multi-layer web produced in accordance with the method of claim 12.

30. A multi-layer web comprising:
a first spun bond non-woven web;
a melt blown non-woven web disposed thereon; and
a second spun bond non-woven web disposed on the melt blown non-woven web.

31. The multi-layer web according to claim 30 further comprising a film.

32. The multi-layer web according to claim 31 wherein the film is disposed between the first spun bond non-woven web and the melt blown non-woven web.

33. A multi-layer web comprising:
a first melt blown non-woven web;
a second melt blown non-woven web disposed thereon; and
a spun bond non-woven web disposed on the second melt blown non-woven web.

34. The multi-layer web according to claim 33 further comprising filler material.

35. The multi-layer web according to claim 34 wherein the filler material is disposed between the first melt blown non-woven web and the second melt blown non-woven web.
